(19) United States
(12) Patent Application Publication
(10) Pub. No.: US 2022/0206212 A1
(43) Pub. Date: Jun. 30, 2022

(54) TPU OPTICAL FIBER AND MANUFACTURING METHOD THEREOF

(71) Applicant: SAN FANG CHEMICAL INDUSTRY CO., LTD., Kaohsiung City (TW)

(72) Inventors: CHIH-YI LIN, KAOHSIUNG CITY (TW); KUO-KUANG CHENG, KAOHSIUNG CITY (TW); KAO-LUNG YANG, KAOHSIUNG CITY (TW); MENG HSIU TSAI, KAOHSIUNG CITY (TW)

(21) Appl. No.: 17/563,806

(22) Filed: Dec. 28, 2021

(30) Foreign Application Priority Data
Dec. 31, 2020 (TW) 109147104

(51) Int. Cl. G02B 6/02; B29C 48/05; B29C 48/21

(52) U.S. Cl. CPC G02B 6/02033; B29K 2101/12; B29C 48/21; B29C 48/05

(57) ABSTRACT

The present disclosure is relates to a TPU optical fiber and a manufacturing method thereof. The TPU optical fiber includes a TPU core layer and a TPU skin layer. The TPU core layer has a first refractive index. The first refractive index is between 1.5˜1.7. The TPU skin layer covers the TPU core layer. The TPU skin layer has a second refractive index. The second refractive index is between 1.4˜1.48. Therefore, the TPU optical fiber of the present disclosure may increase light guide distance, and has good softness, good flexibility, good extensibility, and a wide range for fiber fineness. In addition, the TPU optical fiber of the present disclosure may be easy to proceed for further process.

### FIELD

The disclosure relates to a TPU optical fiber and a manufacturing method thereof.

### BACKGROUND

Conventional optical fibers often use high refractive index materials, such as quartz glass. However, because quartz glass has high light transmittance, that is, it is a highly amorphous material, it is brittle and has poor flexibility. At the same time, the fibers are stiff, and are not suitable to be woven into textiles. Most of the fibers are in the form of cables, which can only be used for data transmission.

### SUMMARY OF THE INVENTION

In accordance with one aspect of the present disclosure, a TPU optical fiber includes: a TPU core layer and a TPU skin layer. The TPU core layer has a first refractive index, and the first refractive index is 1.5-1.7. The TPU skin layer covers the TPU core layer. The TPU skin layer has a second refractive index, and the second refractive index is 1.4-1.48.

In accordance with another aspect of the present disclosure, a manufacturing method of a TPU optical fiber includes: preparing a molten TPU core laver, the TPU core layer having a first refractive index, the first refractive index being 1.5-1.7; preparing a molten TPU skin layer, the TPU skin layer having a second refractive index, the second refractive index being 1.4-1.48; conjugating the molten TPU core layer and the molten TPU skin layer, such that the TPU skin layer covers the TPU core layer, forming the TPU optical fiber; and extending and setting the TPU optical fiber.

### BRIEF DESCRIPTION OF THE DRAWINGS

Aspects of the present disclosure are understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 shows a schematic cross-sectional view of a TPU optical fiber according to an embodiment of the present disclosure.

FIG. 2 shows a schematic side view of a TPU optical fiber according to an embodiment of the present disclosure.

FIG. 3 shows a flowchart of a manufacturing method of a TPU optical fiber according to an embodiment of the present disclosure.

### DETAILED DESCRIPTION OF THE INVENTION

It is to be understood that the following disclosure provides many different embodiments or examples, for implementing different features of various embodiments. Specific examples of components and arrangements are described below to simplify the present disclosure. The present disclosure may, however, be embodied in many different forms and should not be construed as being limited to the embodiments set forth herein; rather, these embodiments are provided so that this description will be thorough and complete, and will fully convey the present disclosure to those of ordinary skill in the art. It will be apparent, however, that one or more embodiments may be practiced without these specific details.

In addition, the present disclosure may repeat reference numerals and/or letters in the various examples. This repetition is for the purpose of simplicity and clarity and does not in itself dictate a relationship between the various embodiments and/or configurations discussed.

It will be understood that when an element is referred to as being “on” another element, it can be directly on the other element or intervening elements may be present. In contrast, when an element is referred to as being “directly on” another element, there are no intervening elements present.

It will be understood that singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms; such as those defined in commonly used dictionaries, should be interpreted as having a meaning that is consistent with their meaning in the context of the relevant art and the present disclosure, and will not be interpreted in an idealized or overly formal sense unless expressly so defined herein.

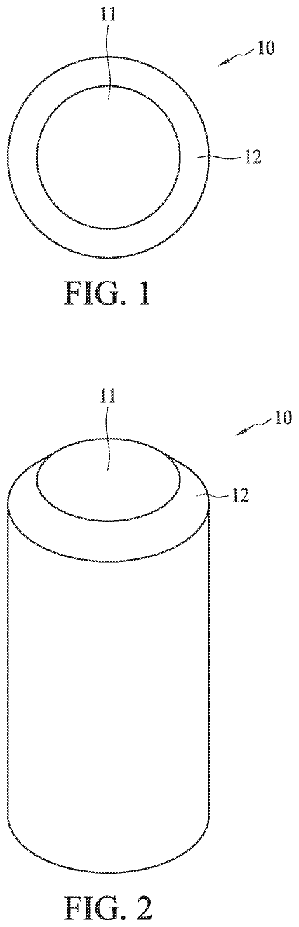

FIG. 1 shows a schematic cross-sectional view of a TPU optical fiber according to an embodiment of the present disclosure. FIG. 2 shows a schematic side view of a TPU optical fiber according to an embodiment of the present disclosure. With reference to FIG. 1 and FIG. 2, in an embodiment, the TPU optical fiber 10 of the present disclosure includes a TPU core layer 11 and a TPU skin layer 12. The TPU optical fiber 10 of the present disclosure is entirely made of TPU. The TPU optical fiber is applicable to textile weaving, but is not limited to the above, and is also applicable to manufacturing in various industries.

In an embodiment, the TPU core layer 11 has a first refractive index. The first refractive index is 1.5-1.7. The TPU skin layer 12 covers the TPU core layer 11. The TPU skin layer 12 has a second refractive index. The second refractive index is 1.4-1.48. The TPU core layer 11 is covered by the TPU skin layer 12, and the second refractive index of the TPU skin layer 12 may be less than the first refractive index of the TPU core layer 11, so that light will not be scattered out, thereby increasing the effective light guide distance.

In an embodiment, a weight ratio of the TPU core layer 11 to the TPU skin layer 12 is 3:7-7:3. In an embodiment, a weight percentage of the TPU skin layer 11 is 40%-70%.

In an embodiment, the TPU optical fiber 10 has a fiber fineness of 75 den-3,000 den. In an embodiment, the TPU optical fiber 10 has a fiber fineness of 900 den-2,500 den. The TPU optical fiber 10 is 100% made of TPU. Therefore, the TPU optical fiber 10 is particularly soft, and has good softness, good flexibility, good extensibility, and a wide range for fiber fineness. In addition, the TPU is a thermoplastic polymer, so the TPU optical fiber 10 may be easy to proceed for further process. The TPU optical fiber 10 can be applied to weaving processes such as woven and knitting.

In an embodiment, the TPU skin layer 12 may have a predetermined. color. In an embodiment, the TPU core layer 11 may also have a predetermined color.

In an embodiment, the TPU optical fiber of the present disclosure may be of monofilament or multifilament. The multifilament includes a plurality of TPU optical fibers 10.

Therefore, the TPU optical fiber 10 of the present disclosure may increase the effective light guide distance, and has good softness, good flexibility, good extensibility, and a wide range for fiber fineness. In addition, the TPU optical fiber 10 may be easy to proceed for further process.

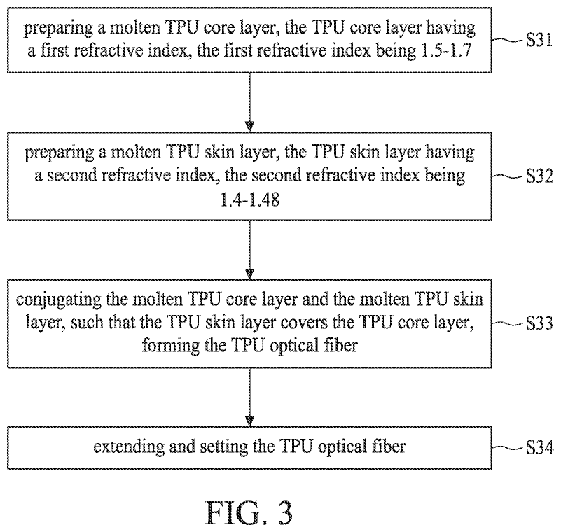

FIG. 3 shows a flowchart of a manufacturing method of a TPU optical fiber according to an embodiment of the present disclosure. With reference to FIG. 1 and FIG. 3, referring to step S31 first, a molten TPU core layer is prepared. The TPU core layer has a first refractive index. The first refractive index is 1.5-1.7.

In an embodiment, the step of preparing the molten TPU core layer further includes the following operations. TPU core layer pellets, having a melting point of 160° C., a Shore hardness of 85 A and a melt flow index of 20, are dried at a predetermined drying temperature for 4 hours until the moisture content is 150 ppm or below. Then, the TPU pellets are molten by a first extruder. The first extruder has a melting temperature of 100° C.-230° C. from the feed port to the discharge port.

Referring to step S32, a molten TPU skin layer is prepared. The TPU skin layer has a second refractive index. The second refractive index is 1.4-1.48.

In an embodiment, the step of preparing the molten TPU skin layer further includes the following operations. TPU skin layer pellets, having a melting point of 100° C.-200° C., a Shore hardness of 40 D-70D or 60 A-100 A and a melt flow index of 6-20, are dried at a predetermined drying temperature for 4 hours until the moisture content is 150 ppm or below. Then, the TPU pellets are molten by a second extruder. The second extruder has a melting temperature of 100° C.-230° C. from the feed port to the discharge port.

In an embodiment, the step of preparing the molten TPU skin layer further includes the following operations. TPU skin layer pellets, having a melting point of 100° C.-200° C., a Shore hardness of 40 D-70 D or 60 A-100 A and a melt flow index of 6-20. are dried at a predetermined drying temperature for 4 hours until the moisture content is 150 ppm or below. TPU pellets with a predetermined color, having a melting point of 100° C.-200° C. and a Shore hardness of 60 A-100 A, are dried at a predetermined drying temperature for 4 hours until the moisture content is 150 ppm or below, and mixed with the treated TPU skin layer pellets. Then, the TPU skin layer pellets and the TPU pellets with the predetermined color are molten by a second extruder. The second extruder has a melting temperature of 100° C.-230° C. from the feed port to the discharge port.

Referring to step S33, the molten TPU core layer and the molten TPU skin layer are conjugated, such that the TPU skin layer covers the TPU core layer, forming the TPU optical fiber.

In an embodiment, in the step of conjugating the molten TPU core layer and the molten TPU skin layer, a first spinning gear pump is used to control the throughput of the molten TPU core layer, and a second spinning gear pump is used to control the throughput of the molten TPU skin layer. A weight ratio of the TPU core layer to the TPU skin layer is 3:7-7:3.

Referring to step S34, the TPU optical fiber is extended and set. In an embodiment, in the step of extending and setting the TPU optical fiber, a plurality of drawing rollers are used to draw and set the TPU optical fiber.

Therefore, the manufacturing method of the TPU optical fiber of the present disclosure does not need to use any solvent that is harmful to the environment, so as to meet the requirement of environmental friendliness. Besides, the TPU optical fiber of the present disclosure can be produced by the melt spinning process, so the procedure is simple, thereby saving the complicated process and time and improving the manufacturing efficiency.

### Embodiment 1

A multifilament melt spinning device was used. TPU core layer pellets, having a refractive index of 1.51, a Shore hardness of 85 A, a melting point of 160° C. and a melt flow index of 20 (ASTM D1238, 210° C./2.16 kg). were prepared and dried in a drying cylinder at 90° C. for 4 hours to control 1.5 the moisture content to be 150 ppm or below. Then, the TPU core layer pellets were conveyed to a first extruder. From the feed port to the discharge port, the operating temperature of the first extruder was set at 150° C. 185° C. and 190° C. The TPU core layer was molten and passed through a first spinning gear pump, and the molten TPU core layer was conveyed into a spinning manifold.

TPU skin layer pellets, having a refractive index of 1.48, a Shore hardness of 60 D, a melting point of 190° C. and a melt flow index of 6 (ASTM D1238, 210° C./2.16 kg), were prepared and dried in a drying cylinder at 100° C. for 4 hours to control the moisture content to 150 ppm or below. Then, the TPU skin layer pellets were conveyed to a second extruder. From the feed port to the discharge port, the operating temperature of the second extruder was set at 170° C., 195° C. and 210° C. The TPU skin layer was molten and passed through a second spinning gear pump, and the molten TPU skin layer was conveyed into the spinning manifold.

The molten TPU core layer having the refractive index of 1.51 and the molten TPU skin layer having the refractive index of 1.48 were respectively passed through the first spinning gear pump and the second spinning gear pump to control the throughput, so that the weight ratio of the molten TPU core layer having the refractive index of 1.51 to the molten TPU skin layer having the refractive index of 1.48 was 30:70. Then, the molten TPU core layer and the molten TPU skin layer were conjugated in a core sheath spinning spinneret to form the TPU optical fiber.

Then, the TPU optical fiber was passed through a cooling air section and cooled by cooling air with a temperature of 23° C. and a relative humidity of 82%. The TPU optical fiber was passed through first drawing rollers having a surface linear velocity of 920 m/min, passed through second drawing rollers having a surface linear velocity of 2,200 m/min and a surface temperature of 90° C. to make the TPU optical fiber drawn by 2.39 times, and passed through third drawing rollers having a surface linear velocity of 2,320 m/min and a surface temperature of 95° C. to heat-set the TPU optical fiber. Then, the TPU optical fiber entered a winder having a velocity of 2,360 m/min, such that the TPU optical fiber was wound into a bobbin.

The TPU optical fiber had the following physical properties: the fiber fineness was 150 d/24 f, the tenacity was 2.6 g/d (ASTM D3822), and the elongation at break was 85% (ASTM D3822). In a test, one end of the TPU optical fiber was connected to a white LED light emitting source having a luminance of 1,000 microcandelas (mcd) at its cross section. The other end of the TPU optical fiber was connected to a luminance meter using a 2048-element detector. The luminance meter could detect light at the other end of the TPU optical fiber, that is, the maximum effective light guide length of the TPU optical fiber could reach 11 m.

### Embodiment 2

A multifilament melt spinning device was used. TPU core layer pellets, having a refractive index of 1.51, a Shore hardness of 85 A, a melting point of 160° C. and a melt flow index of 20 (ASTM D1238 210° C./2.16 kg), were prepared and dried in a drying cylinder at 90° C. for 4 hours to control the moisture content to be 150 ppm or below. Then, the TPU core layer pellets were conveyed to a first extruder. From the feed port to the discharge port, the operating temperature of the first extruder was set at 15+0° C., 185° C. and 190° C. The TPU core layer was molten and passed through a first spinning gear pump, and the molten TPU core layer was conveyed into a spinning manifold.

TPU skin layer pellets, having a refractive index of 1.48, a Shore hardness of 92 A, a melting point of 158° C. and a melt flow index of 16 (ASTM D1238 190° C./2.16 kg), were prepared and dried in a drying cylinder at 80° C. for 4 hours to control the moisture content to 150 ppm or below. Then, the TPU skin layer pellets were conveyed to a second extruder. From the feed port to the discharge port, the operating temperature of the second extruder was set at 170° C., 190° C. and 195° C. The TPU skin layer was molten and passed through a second spinning metering gear pump, and the molten TPU skin layer was conveyed into the spinning manifold.

The molten TPU core layer having the refractive index of 1.51 and the molten TPU skin layer having the refractive index of 1.48 were respectively passed through the first spinning metering gear pump and the second spinning metering gear pump to control the throughput, so that the weight ratio of the molten TPU core layer having the refractive index of 1.51 to the molten TPU skin layer having the refractive index of 1.48 was 50:50. Then, the molten TPU core layer and the molten TPU skin layer were conjugated in a core sheath spinning spinneret to form the TPU optical fiber.

Then, the TPU optical fiber was passed through a cooling air section and cooled by cooling air with a temperature of 21° C. and a relative humidity of 85%. The TPU optical fiber was passed through first drawing rollers having a surface linear velocity of 830 m/min, passed through second drawing rollers having a surface linear velocity of 1,950 m/min and a surface temperature of 70° C., and passed through third drawing rollers having a surface linear velocity of 2,200 m/min and a surface temperature of 85° C. to heat-set the TPU optical fiber. Then, the TPU optical fiber entered a winder having a velocity of 2,280 m/min, such that the TPU optical fiber was wound into a bobbin.

The TPU optical fiber had the following physical properties: the fiber fineness was 75 d/72 f, the tenacity was 2.0 g/d, and the elongation at break was 76%. In a test, one end of the TPU optical fiber was connected to a white LED light emitting source having a luminance of 1,000 microcandelas (mcd) at its cross section. The other end of the TPU optical fiber was connected to a luminance meter using a 2048-element detector. The luminance meter could detect light at the other end of the TPU optical fiber, that is, the maximum effective light guide length of the TPU optical fiber could reach 9 m.

### Embodiment 3

A monofilament melt spinning device was used. TPU core layer pellets, having a refractive index of 1.52, a Shore hardness of 85 A, a melting point of 1.60° C. and a melt flow index of 20 (ASTM D1238 210° C./2.16 kg), were prepared and dried in a drying cylinder at 90° C. for 4 hours to control the moisture content to be 150 ppm or below. Then, the TPU core layer pellets were conveyed to a first extruder. From the feed port to the discharge port, the operating temperature of the first extruder was set at 145° C., 150° C., 185° C. and 185° C. The TPU core layer was molten and passed through a first spinning metering gear pump, and the molten TPU core layer was conveyed into a spinning manifold.

TPU skin layer pellets, having a refractive index of 1.48, a Shore hardness of 45 D, a melting point of 175° C. and a melt flow index of 19 (ASTM D1238 190° C./2.16 kg), were prepared and dried in a drying cylinder at 80° C. for 4 hours to control the moisture content to 150 ppm or below. Then, the TPU skin layer pellets were conveyed to a second extruder. From the feed port to the discharge port, the operating temperature of the second extruder was set at 140° C., 170° C., 190° C. and 190° C. The TPU skin layer was molten and passed through a second spinning metering gear pump, and the molten TPU skin layer was conveyed into the spinning manifold.

The molten TPU core layer having the refractive index of 1.52 and the molten TPU skin layer having the refractive index of 1.48 were respectively passed through the first spinning metering gear pump and the second. spinning metering gear pump to control the throughput, so that the weight ratio of the molten TPU core layer having the refractive index of 1.52 to the molten TPU skin layer having the refractive index of 1.48 was 65:35. Then, the molten TPU core layer and the molten TPU skin layer were conjugated in a core sheath spinning spinneret to form the TPU optical fiber.

Then, the TPU optical fiber was passed through a cooling water section and cooled by cooling water with a temperature of 16° C. The TPU optical fiber was passed through first drawing rollers having a surface linear velocity of 30 m/min, then passed through a first heating water tank and the water with a temperature of 60° C., then passed through second drawing rollers having a surface linear velocity of 85 m/min to make the TPU optical fiber drawn by 2.83 times, then passed through a first heating air section and the heating air with a temperature of 75° C., then passed through third drawing rollers having a surface linear velocity of 110 ml/min to make the TPU optical fiber drawn by 1.47 times, then passed through a second heating air section and the heating air with a temperature of 85° C., then passed through drawing rollers having a surface linear velocity of 115 m/min to heat-set the TPU optical fiber. Then, the TPU optical fiber entered a winder having a velocity of 118 m/min, such that the TPU optical fiber was wound into a bobbin.

The TPU optical fiber had the following physical properties: the fiber fineness was 600 d/1 f, the strength was 2.3 g/d, and the elongation at break was 90%. In a test, one end of the TPU optical fiber was connected to a white LED light emitting source having a luminance of 1,000 microcandelas (mcd) at its cross section. The other end of the TPU optical fiber was connected to a luminance meter using a 2048-element detector. The luminance meter could detect light at the other end of the TPU optical fiber, that is, the maximum effective light guide length of the TPU optical fiber could reach 13 m.

### Embodiment 4

A monofilament melt spinning device was used. TPU core layer pellets, having a refractive index of 1.53, a Shore hardness of 85 A, a melting point of 160° C. and a melt flow index of 20 (ASTM D1238 210° C./2.16 kg), were prepared and dried in a drying cylinder at 90° C. for 4 hours to control the moisture content to be 150 ppm or below. Then, the TPU core layer pellets were conveyed to a first extruder. From the feed port to the discharge port, the operating temperature of the first extruder was set at 145° C., 150° C., 185° C. and 185° C. The TPU core layer was molten and passed through a first spinning metering gear pump, and the molten TPU core layer was conveyed into a spinning manifold.

TPU skin layer pellets, having a refractive index of 1.46, a Shore hardness of 70 A, a melting point of 155° C. and a melt flow index of 17 (ASTM 11238 190° C./2.16 kg), were prepared and dried in a drying cylinder at 80° C. for 4 hours to control the moisture content to 150 ppm or below. Then, TPU parent pellets with a silver color were prepared, the content of the silver color powder in TPU parent pellets is 15%. The TPU parent pellets having a Shore hardness of 70 A, are dried in another drying cylinder at 90° C. for 4 hours to control the moisture content to 150 ppm or below. The treated TPU skin layer pellets having the refractive index of 1.46 and the TPU parent pellets with the silver color are mixed with the weight ratio 97:3, then, were conveyed to a second extruder. From the feed port to the discharge port, the operating temperature of the second extruder was set at 135° C., 160° C., 175° C. and 175° C. The TPU skin layer and TPU parent pellets with the silver color were molten and passed through a second spinning metering gear pump, and the molten TPU skin layer with the silver color was conveyed into the spinning manifold.

The molten TPU core layer having the refractive index of 1.53 and the molten TPU skin layer having the refractive index of 1.46 and the silver color were respectively passed through the first spinning metering gear pump and the second spinning metering gear pump to control the throughput, so that the weight ratio of the molten TPU core layer having the refractive index of 1.53 to the molten TPU skin layer having the refractive index of 1.46 and the silver color was 70:30. Then, the molten TPU core layer and the molten TPU skin layer were conjugated in a core sheath spinning spinneret to form the TPU optical fiber.

Then, the TPU optical fiber was passed through a cooling water section and cooled by cooling water with a temperature of 15° C. The TPU optical fiber was passed through first drawing rollers having a surface linear velocity of 35 m/min, then passed through a first heating water tank and the water with a temperature of 60° C., then passed through second drawing rollers having a surface linear velocity of 80 m/min to make the TPU optical fiber drawn by 2.28 times, then passed through a first heating air section and the heating air with a temperature of 72° C., then passed through third drawing rollers having a surface linear velocity of 85 m/min to make the TPU optical fiber drawn by 1.06 times, then passed through a second heating air section and the heating air with a temperature of 80° C., then passed through fourth drawing rollers having a surface linear velocity of 90 m/min to heat-set the TPU optical fiber. Then, the TPU optical fiber entered a winder having a velocity of 92 m/min, such that the TPU optical fiber was wound into a bobbin.

The TPU optical fiber had the following physical properties: the fiber fineness was 1800 d/1 f, the strength was 1.8 g/d, and the elongation at break was 103%. In a test, one end of the TPU optical fiber was connected to a white LED light emitting source having a luminance of 1,000 microcandelas (mcd) at its cross section. The other end of the TPU optical fiber was connected to a luminance meter using a 2048-element detector. The luminance meter could detect light at the other end of the TPU optical fiber, that is, the maximum effective light guide length of the TPU optical fiber could reach 16 m.

Table. 1 shows a list of the fiber fineness and the effective light guide length of the above embodiments.

TABLE 1

| | Embodi- | Embodi- | Embodi- | Embodi- |
|---|---|---|---|---|
| | ment 1 | ment 2 | ment 3 | ment 4 |
| fiber | 150/24 | 75/72 | 600/1 | 1800/1 |
| fineness (d/f) | | | | |
| effective | 11 | 9 | 13 | 16 |
| light guide | | | | |
| length (m) | | | | |

Moreover, the scope of the present application is not intended to be limited to the particular embodiments of the process, machine, manufacture, and composition of matter, means, methods and steps described in the specification. As those skilled in the art will readily appreciate form the present disclosure, processes, machines, manufacture, compositions of matter, means, methods, or steps, presently existing or later to be developed, that perform substantially the same function or achieve substantially the same result as the corresponding embodiments described herein may be utilized in accordance with some embodiments of the present disclosure.

Accordingly, the appended claims are intended to include within their scope such processes, machines, manufacture, and compositions of matter, means, methods or steps. In addition, each claim constitutes a separate embodiment, and the combination of various claims and embodiments are within the scope of the invention.

What is claimed is:

1. A TPU optical fiber, comprising:
a TPU core layer, having a first refractive index, the first refractive index being 1.5-1.7; and
a TPU skin laver, covering the TPU core laver, the TPU skin layer having a second refractive index, the second refractive index being 1.4-1.48.

2. The TPU optical fiber of claim 1, wherein a weight ratio of the TPU core layer to the TPU skin layer is 3:7-7:3.

3. The TPU optical fiber of claim 2, wherein a weight percentage of the TPU skin layer is 40%-70%.

4. The TPU optical fiber of claim 1, wherein the TPU optical fiber has a fiber fineness of 75 den-3,000 den,

5. TPU optical fiber of claim 4, wherein The TPU optical fiber has a fiber fineness of 900 den-2,500 den.

6. The TPU optical fiber of claim 1, wherein the TPU skin layer have a predetermined color.

7. A manufacturing of a TPU optical fiber, comprising:
preparing a molten TPU core layer, the TPU core layer having a first refractive index, the first refractive index being 1.5-1.7;
preparing a molten TPU skin layer, the TPU skin layer having a second refractive index, the second refractive index being 1.4-1.48;
conjugating the molten TPU core layer and the molten TPU skin layer, such that the TPU skin layer covers the TPU core layer, forming the TPU optical fiber; and
extending and setting the TPU optical fiber.

8. The manufacturing method of claim 7, wherein the step of preparing a molten TPU core layer further comprises: using TPU core layer pellets having a melting point of 160° C., a Shore hardness of 85 A and a melt flow index of 20, and drying the TPU core layer pellets at a predetermined drying temperature for 4 hours until the moisture content is 150 ppm or below, then, melting the TPU core layer pellets by a first extruder, the first extruder having a melting temperature of 100° C.-230° C. from a feed port to a discharge port.

9. The manufacturing method of claim 7, wherein the step of preparing a molten TPU skin layer further comprises: using TPU skin layer pellets having a melting point of 100° C.-200° C., a Shore hardness of 40 D-70 D or 60 A-100 A and a melt flow index of 6-20 (ASTM D1238), and drying the TPU skin layer pellets at a predetermined drying temperature for 4 hours until the moisture content is 150 ppm or below, then, melting the TPU skin layer pellets by a second extruder, the second extruder having a melting temperature of 100° C.-230° C. from a feed port to a discharge port.

10. The manufacturing method of claim 7, wherein the step of preparing a molten TPU skin layer further comprises: using TPU skin layer pellets having a melting point of 100° C.-200° C., a Shore hardness of 40 D-70 D or 60 A-100 A and a melt flow index of 6-20 (ASTM D1238), drying TPU skin layer pellets at a predetermined drying temperature for 4 hours until the moisture content is 150 ppm or below, using TPU pellets with a predetermined color, having a melting point of 100° C.-200° C. and a Shore hardness of 60 A-100 A, drying TPU pellets with the predetermined color at a predetermined drying temperature for 4 hours until the moisture content is 150 ppm or below, and mixed with the treated TPU skin layer pellets, then, melting the TPU skin layer pellets and the TPU pellets with the predetermined color by a second extruder, the second extruder having a melting temperature of 100° C.-230° C. from a feed port to a discharge port.

11. The manufacturing method of claim 7, wherein the step of conjugating the molten TPU core layer and the molten TPU skin layer further comprises: using a first spinning metering gear pump to control the throughput of the molten TPU core layer, and using a second spinning metering gear pump to control the throughput of the molten TPU skin layer, a weight ratio of the TPU core layer to the TPU skin layer being 3:7-7:3.

12. The manufacturing method of claim 7, wherein the step of drawing and setting the TPU optical fiber further comprises: using a plurality of drawing rollers to draw and set the TPU optical fiber.
